(19) United States
(12) Patent Application Publication
(10) Pub. No.: US 2006/0215268 A1
(43) Pub. Date: Sep. 28, 2006

(54) Light diffraction plate

(75) Inventors: Kinju Taya, Miao-Li Hsien (TW); Chao-Hung Tseng, Shan City (TW)

Correspondence Address: FROMMER LAWRENCE & HAUG, 745 FIFTH AVENUE- 10TH FL., NEW YORK, NY, 10151, US

(73) Assignee: Main Source Technology Co., Ltd.

(21) Appl. No.: 11/091,561

(22) Filed: Mar. 28, 2005

(51) Int. Cl. G02B 21/00

(52) U.S. Cl. 359/569; 359/566

(57) ABSTRACT

A light diffraction plate includes a light transmissive layer, and at least one light diffraction layer which is formed on the light transmissive layer, and which has a plurality of light diffraction units. The light diffraction units are formed as protrusions or indentations, and are formed by hot pressing or embossing and curing.

### BACKGROUND OF THE INVENTION

1. Field of the Invention

The invention relates to a light diffraction plate, more particularly to a light diffraction plate having high transmittance.

2. Description of the Related Art

Referring to FIG. 1, a conventional light diffraction plate 1 is made by blending a high proportion of diffraction particles 11 with a light transmissive polymer, such as polymethyl methacrylate (PMMA), polycarbonate (PC), methyl styrene (MS), or polystyrene (PS), to form a mixture, and molding the mixture by casting or extrusion. The light diffraction plate 1 can be cut according to requirements in actual practice. It should be noted that the diffraction particles 11 are not drawn to scale in FIG. 1 and are actually illustrated in a magnified form for the sake of clarity.

As shown by the arrows in FIG. 1, the light from light sources 10 is diffracted by the diffraction particles 11 so as to achieve a light diffraction effect. However, the diffraction particles 11 can block light transmission, which may result in a reduction in light transmittance. The uneven distribution of the diffraction particles 11 can also cause uneven light diffraction. Furthermore, the cost for producing the conventional light diffraction plate 1 may increase due to the use of the diffraction particles 11. Additionally, as shown in FIG. 1, when the conventional light diffraction plate 1 is used in a direct bottom type backlight module, the light sources 10 are spaced apart from each other and are disposed below the light diffraction plate 1. Because of this and the aforesaid uneven distribution of the diffraction particles 11, a uniform brightness cannot be achieved. Therefore, the conventional light diffraction plate 1 is required to undergo a mask-printing treatment so as to obtain a uniform brightness, which complicates the process of making the conventional light diffraction plate 1 and reduces the light transmittance effect.

### SUMMARY OF THE INVENTION

Therefore, it is an object of the present invention to provide a light diffraction plate which has high transmittance and which is easy to make, so as to overcome the aforesaid disadvantages of the prior art.

Accordingly, the light diffraction plate according to this invention includes a light transmissive layer, and at least one light diffraction layer formed on the light transmissive layer and having a plurality of light diffraction units.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional light diffraction plate when used in conjunction with light sources;

FIG. 2 is a fragmentary top view of the first preferred embodiment of the light diffraction plate according to this invention;

FIG. 3 is a fragmentary side view of the first preferred embodiment;

FIG. 4 is a schematic view of the first preferred embodiment when used in conjunction with light sources;

FIG. 5 is a fragmentary top view of the second preferred embodiment of the light diffraction plate according to this invention;

FIG. 6 is a fragmentary side view of the second preferred embodiment;

FIG. 7 is a fragmentary top view of the third preferred embodiment of the light diffraction plate according to this invention;

FIG. 8 is a fragmentary top view of the fourth preferred embodiment of the light diffraction plate according to this invention;

FIG. 9 is a fragmentary top view of the fifth preferred embodiment of the light diffraction plate according to this invention;

FIG. 10 is a fragmentary top view of the sixth preferred embodiment of the light diffraction plate according to this invention; and

FIG. 11 is a fragmentary sectional view of the seventh preferred embodiment of the light diffraction plate according to this invention.

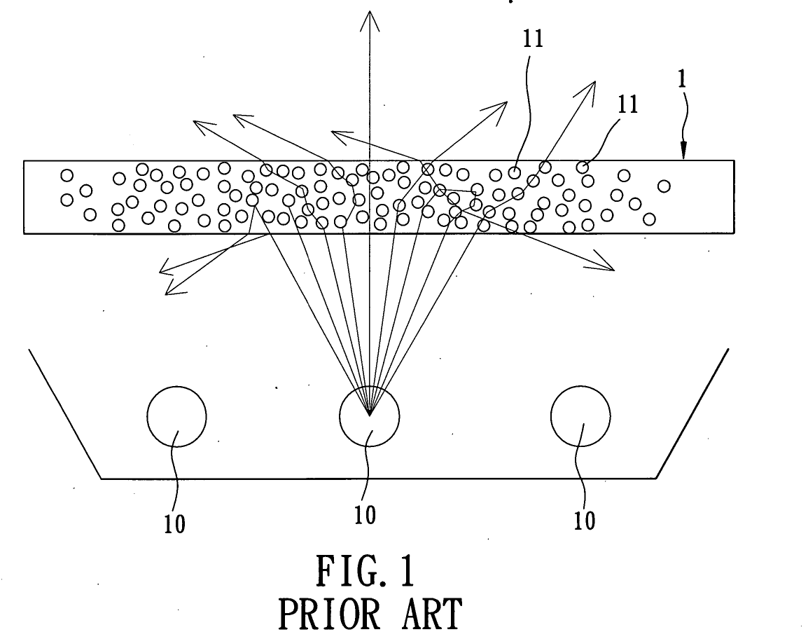

### DETAILED DESCRIPTION OF THE PREFERRED EMBODIMENTS

Before the present invention is described in greater detail, it should be noted that like elements are denoted by the same reference numerals throughout the disclosure.

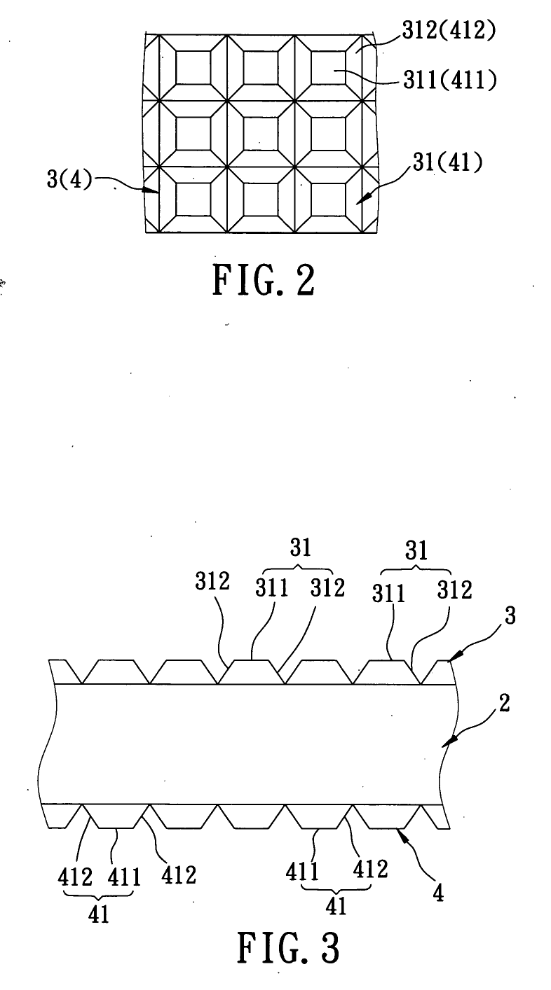

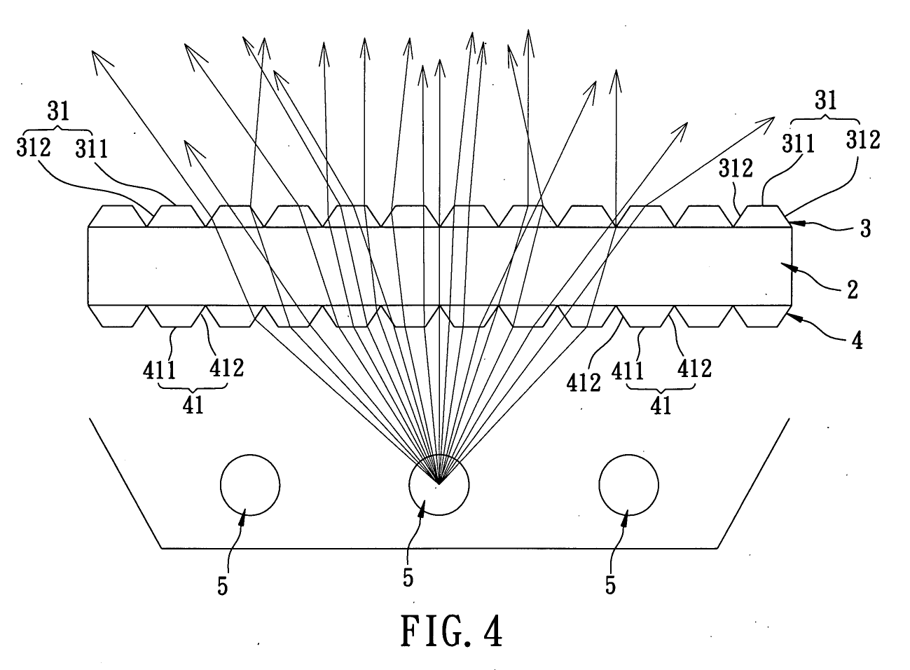

Referring to FIGS. 2 and 3, the first preferred embodiment of a light diffraction plate according to this invention is shown to include a light transmissive layer 2; a top light diffraction layer 3 formed on top of the light transmissive layer 2, and a bottom light diffraction layer 4 formed below the light transmissive layer 2. The top light diffraction layer 3 includes a plurality of top light diffraction units 31. The bottom light diffraction layer 4 includes a plurality of bottom light diffraction units 41. Each of the top and bottom light diffraction units 31,41 is formed as a protrusion. In this preferred embodiment, the protrusion has the shape of a truncated square-based pyramid, and includes a flat surface 311,411, and a plurality of side surfaces 312,412. The top and bottom light diffraction layers 3,4 and the light transmissive layer 2 are formed integrally as a one-piece body using a thermoplastic polymer. The top and bottom light diffraction units 31,41 are formed by hot pressing the one-piece body. Referring to FIG. 4, the light from light sources 5 can be diffracted by the top and bottom light diffraction units 31,41 to obtain a relatively uniform brightness. Furthermore, a relatively wide viewing angle can be obtained so as to enhance the diffraction effect. Additionally, since the diffraction particles 11 required in the prior art are not used in this invention, the disadvantage associated therewith can be avoided. When a plurality of the light sources 5 are used simultaneously, the diffraction effect can be further improved.

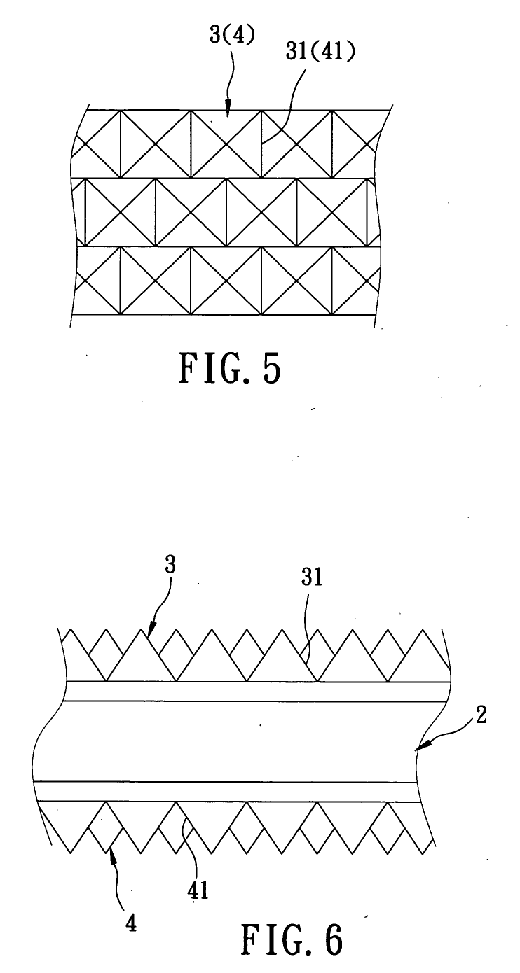

Referring to FIGS. 5 and 6, the second preferred embodiment of a light diffraction plate according to this invention is similar to the first preferred embodiment except that each of the top and bottom light diffraction layers 3,4 is formed by applying a coating to the light transmissive layer 2, followed by embossing and curing the coating to form the top and bottom light diffraction units 31,41. The coating is an ultra-violet curable coating material, and is cured by ultra-violet light. In this preferred embodiment, each of the top and bottom light diffraction units 31,41 is formed as a protrusion having the shape of a square-based pyramid.

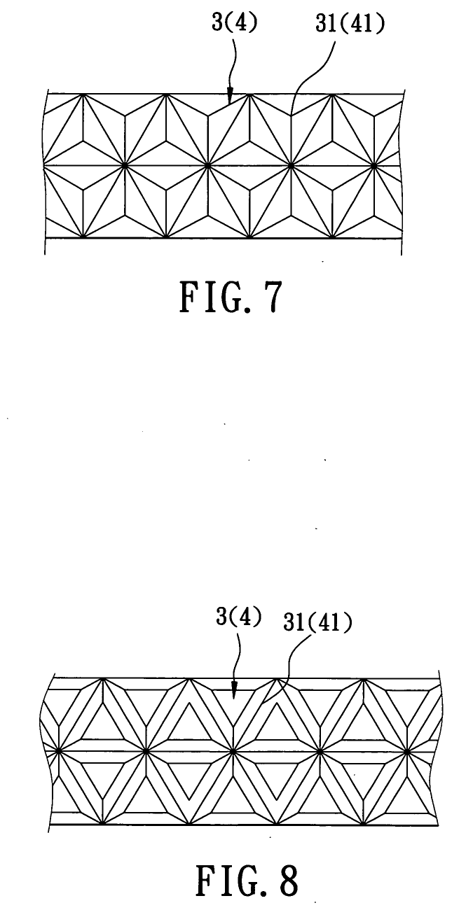

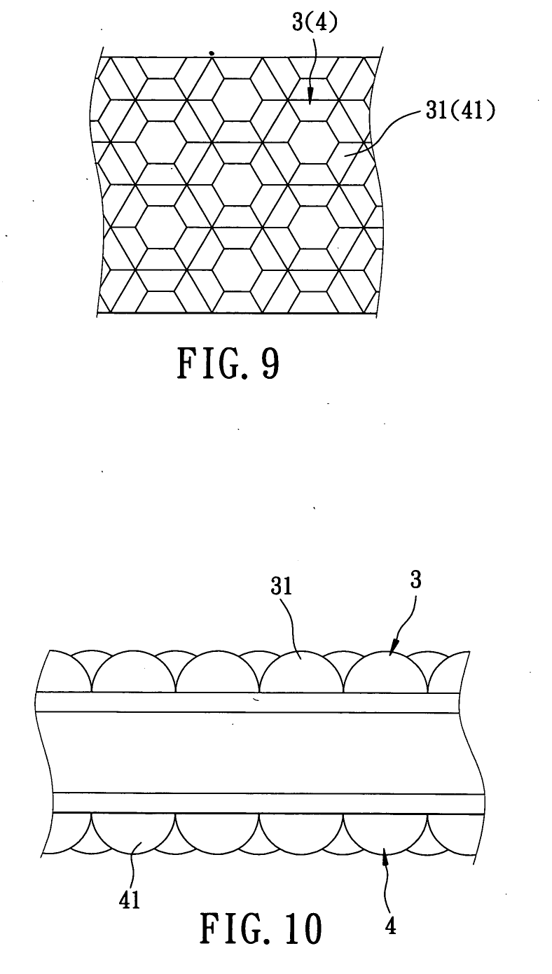

Referring to FIGS. 7, 8, 9, and 10, each of the top and bottom light diffraction units 31,41 can be formed as a protrusion having other shapes, such as a triangular pyramid, a truncated triangular pyramid, a truncated hexagonal pyramid, a semi-sphere, and the like.

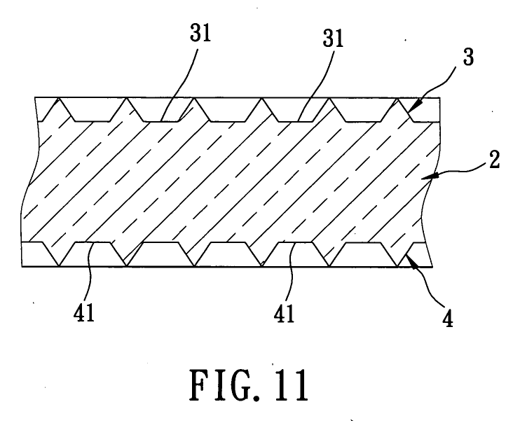

Referring to FIG. 11, each of the top and bottom light diffraction units 31,41 can also be formed as an indentation having the aforesaid shapes, such as the truncated square-based pyramid, the square-based pyramid, the triangular pyramid, the truncated triangular pyramid, the truncated hexagonal pyramid, the semi-sphere, and the like.

It should be noted that the size, geometry, and distribution of the top and bottom light diffraction units 31,41 can be varied according to requirement in actual practice.

In view of the aforesaid, the light diffraction plate of this invention has the following advantages:

1. Since the diffraction particles 11 required in the prior art are not used in this invention, the light transmittance of the light diffraction plate of this invention will not be adversely affected thereby.

2. Since the size, geometry, and distribution of the top and bottom light diffraction units 31,41 can be specified according to requirements, the brightness uniformity of the light diffraction plate of this invention can be improved over the prior art in which the diffraction particles 11 are distributed unevenly.

3. Since the top and bottom light diffraction units 31,41 can be formed easily by hot pressing or by embossing and curing, and since the mask-printing treatment required in the prior art is not necessary in this invention, the light diffraction plate of this invention can be produced in an easy and fast manner. Therefore, the cost for making the light diffraction plate of this invention can be reduced as compared to that of the prior art.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A light diffraction plate, comprising:
a light transmissive layer; and
at least one light diffraction layer formed on said light transmissive layer, and including a plurality of light diffraction units.

2. The light diffraction plate as claimed in claim 1, wherein said light transmissive layer is made of polymers.

3. The light diffraction plate as claimed in claim 1, wherein each of said light diffraction units is formed as a protrusion.

4. The light diffraction plate as claimed in claim 3, wherein said protrusion has a shape selected from the group consisting of a truncated square-based pyramid, a square-based pyramid, a triangular pyramid, a truncated triangular pyramid, a truncated hexagonal pyramid, and a semi-sphere.

5. The light diffraction plate as claimed in claim 1, wherein each of said light diffraction units is formed as an indentation.

6. The light diffraction plate as claimed in claim 5, wherein said indentation has a shape selected from the group consisting of a truncated square-based pyramid, a square-based pyramid, a triangular pyramid, a truncated triangular pyramid, a truncated hexagonal pyramid, and a semi-sphere.

7. The light diffraction plate as claimed in claim 1, wherein said light diffraction layer and said light transmissive layer are formed integrally as a one-piece body, said light diffraction units being formed by hot pressing said one-piece body.

8. The light diffraction plate as claimed in claim 7, wherein said one-piece body is made of a thermoplastic polymer.

9. The light diffraction plate as claimed in claim 1, wherein said light diffraction layer is formed by applying a coating to said light transmissive layer, followed by embossing and curing said coating to form said light diffraction units.

10. The light diffraction plate as claimed in claim 9, wherein said coating is an ultra-violet curable coating material.
